(19) United States
(12) Patent Application Publication
(10) Pub. No.: US 2009/0099903 A1
(43) Pub. Date: Apr. 16, 2009

(54) METHOD, SYSTEM AND DATABASE FOR POST-MARKETING SURVEILLANCE AND EVALUATION OF DRUGS

(76) Inventor: Lucien ABENHAIM, London (GB)

Correspondence Address: NIXON & VANDERHYE, PC, 901 NORTH GLEBE ROAD, 11TH FLOOR, ARLINGTON, VA, 22203, US

(21) Appl. No.: 12/184,561

(22) Filed: Aug. 1, 2008

Related U.S. Application Data
(60) Provisional application No. 60/953,774, filed on Aug. 3, 2007.

(51) Int. Cl. G06F 17/30; G06Q 50/00; G06Q 40/00

(52) U.S. Cl. 705/10; 705/7; 705/3; 705/4

(57) ABSTRACT

A system and a method for surveying and assessing the contribution of drugs risks of adverse events, comprising a) identification and studying: a plurality of case-groups of different categories of adverse events, each case of a given case-group being faced with a given adverse event; a pool of potential referents identified regardless of a previous medical history thereof; and a large number of drugs and vaccines used by the cases and the potential referents; b) selecting controls sampled from the pool of potential referents according to predetermined criteria; c) matching the controls to specific cases of the case-groups; and d) conducting statistical analyses by comparing cases and controls to identify drugs that are susceptible to be associated with a modified risk of at least one of the adverse events and factors associated with this risk; wherein the steps a) to d) are performed on a systematic prospective on-going plan.

### CROSS REFERENCE TO RELATED APPLICATIONS

This application claims priority, under 35 U.S.C. § 119(e), of U.S. provisional application Ser. No. 60/953,774, filed on Aug. 3, 2007. All documents above are incorporated herein in their entirety by reference.

### FIELD OF THE INVENTION

The present invention relates to the field of pharmaco-epidemiology. More specifically, the present invention relates to post-marketing surveillance and evaluation of drugs.

### BACKGROUND OF THE INVENTION

Despite careful pre-marketing studies of drugs via Phase I-III clinical trials, adverse effects of drugs are commonly observed after marketing, and may even lead to drug recalls. In fact, pre-marketing studies generally involve a limited number of highly selected subjects who only have the disease that is targeted by the drug of interest and are carried on for short-term periods, which conditions cannot reflect the real world setting of care, which involves co-morbidities and co-medications. Thus such pre-marketing studies of drugs do not have sufficient statistical power to detect or rule out rare or delayed onset adverse drug effects.

Pharmaco-vigilance systems have been implemented internationally to trigger spontaneous reports of adverse drug reactions by health care providers and patients, leading to the development of databases compiling suspected adverse reactions to drugs. However, the efficiency of such systems is generally weakened by reporting biases.

When an alarm occurs, i.e. once a potential risk is detected by a pharmaco-vigilance system or suspected from the results of pre-marketing studies, two routes may usually be followed to evaluate such risk: the analysis of existent automated databases of prescription records such as health insurance databases or of computerized general medical records (‘automated databases’) may be performed or an observational pharmaco-epidemiological study, with the de novo collection of data to ensure sufficient specificity to the information and the documentation of confounders, may be conducted. Both methods are limited by some biases.

As used herein, the term “bias” generally designates an error or distortion of information that differs or not between the cases and the referents. Such error or distortion, if it is equally distributed between cases and referents, constitute a non-differential bias, otherwise it is a differential bias. Non differential biases decrease the probability of observing existing associations between an exposure and an outcome, while differential biases may lead to unfounded observation of spurious associations.

The use of automated databases in pharmaco-epidemiology is the standard practice as it may reduce the delay for obtaining the results and the opportunity for selection biases to occur, but it presents two limitations, namely the fact that these automated databases are not constituted especially for pharmaco-epidemiological purposes and thus usually lack the specificity of information required as they do not readily contain consistent patient information with highly validated diagnostic information, especially for diseases difficult to ascertain, and the fact that those automated databases that have some specificity do not contain sufficient patient data to perform a statistically significant search, especially for rare diseases or diseases occurring on the long term. Furthermore, none of the existent automated databases used in pharmaco-epidemiology contain valid information on family history of disease or on a series of behaviour-related risk factors that may play a confounding role in the occurrence of adverse events, such as for example smoking, alcohol intake or obesity. Moreover, and even more importantly so, none of the existing database readily ensure that the adverse events considered are occurring for the first time in the life of the patients (so called ‘incident cases’) and they lack data to identify the date of first symptoms with precision.

Some attempts are made at mitigating these limitations of automated databases by validating their content. These validations are themselves conducted either on an ad hoc basis, for the study of a relation between a particular drug and a given disease or, on the contrary, ‘statistically’. None of these approaches reach a level of medical specificity comparable to that achieved by de novo recruitment of patients into clinical and epidemiological studies.

As an alternative to automated databases, pharmaco-epidemiology uses observational studies to collect ad hoc valid information on patients. One method of choice is the cohort design, which identifies patients exposed to a given drug, either directly or indirectly, and follows them up over time. This method is not efficient for the study of rare or delayed adverse events as it requires the recruitment and follow-up of very large samples of patients. By design, it limits the number of risk factors and drugs surveyed for a given adverse event.

Another methodological approach used in observational studies is the case-control design (or “case-referent” design), which is especially adapted to the study of rare or delayed events and to the simultaneous documentation of several exposures and risk factors. It allows for the recruitment of incident cases of disease. Instead of studying a group of patients taking the same drug—or having a common exposure to a drug—until they have a specific event, as in the cohort design mentioned hereinabove, a case-control design generally starts with the identification of a group of patients with a common event or disease. These patients are the cases. Sampled controls are subjects representative of the underlying population from which the cases were identified but who have not developed the event or disease of interest yet. Controls are recruited on a one by one basis to be as comparable as possible to the cases. The exposure of the cases and controls to a drug and other risk factors is then ascertained on a one by one basis and can then be compared and analyzed. As it starts with cases, the case-control design is very efficient for the study of rare or delayed diseases. As it documents cases and controls retrospectively, the case-control design allows for the simultaneous study of a very large number of risk factors for the disease.

These case-control studies are usually conducted on an ad hoc basis to address drug risk issues and are often impaired by a number of limitations. Not only each ad hoc, one-by-one approach takes time, but it is in itself the source of several possible biases which require enormous efforts to be minimized and which have limited greatly its use in pharmaco-epidemiology, despite noticeable exceptions. The main concerns with the classical case-control design are the selection bias where the cases and controls are more or less likely to be selected on the basis of their exposure status and the recall bias where patients with the adverse event are more or less likely to report their drug intake than controls. Also, the identification and recruitment of unbiased controls as similar as possible to the cases to be validly compared with them has proven to be a very hazardous and time consuming exercise in the one-by-one ad hoc approaches.

Several attempts have been made and exist to recruit cases of adverse events and compare them to controls on a systematic basis. The concept of systematic recruitment of cases and controls has been considered in the pharmaco-epidemiological community for several decades and its need called for at several occasions. It has not given birth to a systematic information system and database to-date, until the present invention, due largely to the lack of solution to the problem of the matching of controls to cases on an ad hoc basis and the enormous efforts necessary to define cases and the referents appropriately for such a systematic case-referent approach. Teams collecting large samples of cases of different pathologies on a routine basis use either ad hoc recruitment of controls or do not recruit controls at all, using estimates of exposure to drugs available from general population surveys (the so-called ‘case-population’ design).

Thus remains a need for a method, information system and database to perform a post-marketing surveillance and evaluation of drugs, which would essentially use the case-control design for its ability to study rare or delayed adverse events and have characteristics of the automated databases for the rapidity of its availability and the minimization of selection and information biases.

The present description refers to a number of documents, the content of which is herein incorporated by reference in their entirety.

### SUMMARY OF THE INVENTION

More specifically, in accordance with the present invention, there is provided a method for surveying and assessing the contribution of drugs risks of adverse events, comprising: a) identification and studying: i) a plurality of case-groups of different categories of adverse events, each case of a given case-group being faced with a given adverse event; ii) a pool of potential referents identified regardless of a previous medical history thereof; and iii) a large number of drugs and vaccines used by the cases and the potential referents; b) selecting controls sampled from the pool of potential referents according to predetermined criteria; c) matching the controls to specific cases of the case-groups; and d) conducting statistical analyses by comparing cases and controls to identify drugs that are susceptible to be associated with a modified risk of at least one of the adverse events and factors associated with this risk; wherein the steps a) to d) are performed on a systematic prospective on-going plan.

There is further provided a system for surveying and assessing the contribution of drugs to the risk of adverse events in a pre-defined population, comprising at least one referent-recruiting unit, forming, from the pre-defined population, a pool of potential referents regardless of their medical history; at least one data collection unit collecting at least drug exposure data of each recruited case and each recruited potential referent; at least one case-recruiting unit for each adverse event, forming a case group for the adverse event from the pre-defined population, each case of the case group being faced with the adverse event; and at least one database comprising the identifiers of the recruited cases, of the recruited potential referents and associated collected data; wherein the recruiting units and the at least one data collection unit are adapted to operate on a systematic prospective on-going plan.

There is further provided a ready-to-use case-referent database set, comprising a number of case groups, each case group comprising cases of a given pathology with identifiers of cases, recruited from a pre-determined population in a systematic consecutive way, each case being assigned an index date; a number of data corresponding to each case of each case group; a pool of potential referents comprising potential referents recruited from the pre-determined population in a systematic consecutive way, each potential referent having an identifier and being assigned a recruitment date; and a number of data corresponding to each recruited potential referent.

There is further provided a method for collecting drug exposure data from patients, comprising at least one of: submitting a list of drugs to the patients; and stimulating the patients' memory of drug use using time windows; and b) submitting a list of health problems to the patients.

Other objects, advantages and features of the present invention will become more apparent upon reading of the following non-restrictive description of specific embodiments thereof, given by way of example only with reference to the accompanying drawings.

### BRIEF DESCRIPTION OF THE DRAWINGS

In the appended drawings:

FIG. 1 is a schematical presentation of a method according to an embodiment of an aspect of the present invention; and

FIG. 2 is a schematical presentation of a system according to an embodiment of an aspect of the present invention.

### DESCRIPTION OF ILLUSTRATIVE EMBODIMENTS

In a nutshell, there is provided a method, system and database based on a dedicated, prospective, systematic consecutive population-based recruitment plan and documentation of cases and of referents for controlled pharmaco-epidemiological studies of rare or delayed adverse events to medicines.

The present method is based on a prospective, systematic consecutive recruitment and documentation of pathology cases and a prospective, systematic consecutive recruitment and documentation of potential referents, independently and without a priori hypothesis, so as to provide case groups and a pool of potential referents, from which some, referred to as controls, can be selected out or compared to the cases.

“The terms ‘control’ and ‘referent’ are used alternatively in the epidemiologic literature for case-control or case-referent designs, although the first one is much more common. A pool of “potential referent” is firstly recruited here. Then “controls” or actual “referents” to each case may be secondarily selected out from this pool to be matched or compared to cases. To simplify reading, the term “potential referents” will be used here when designing the referents recruited in the pool and the term “control” will be used for the referents selected out from the pool to be matched or compared to cases.

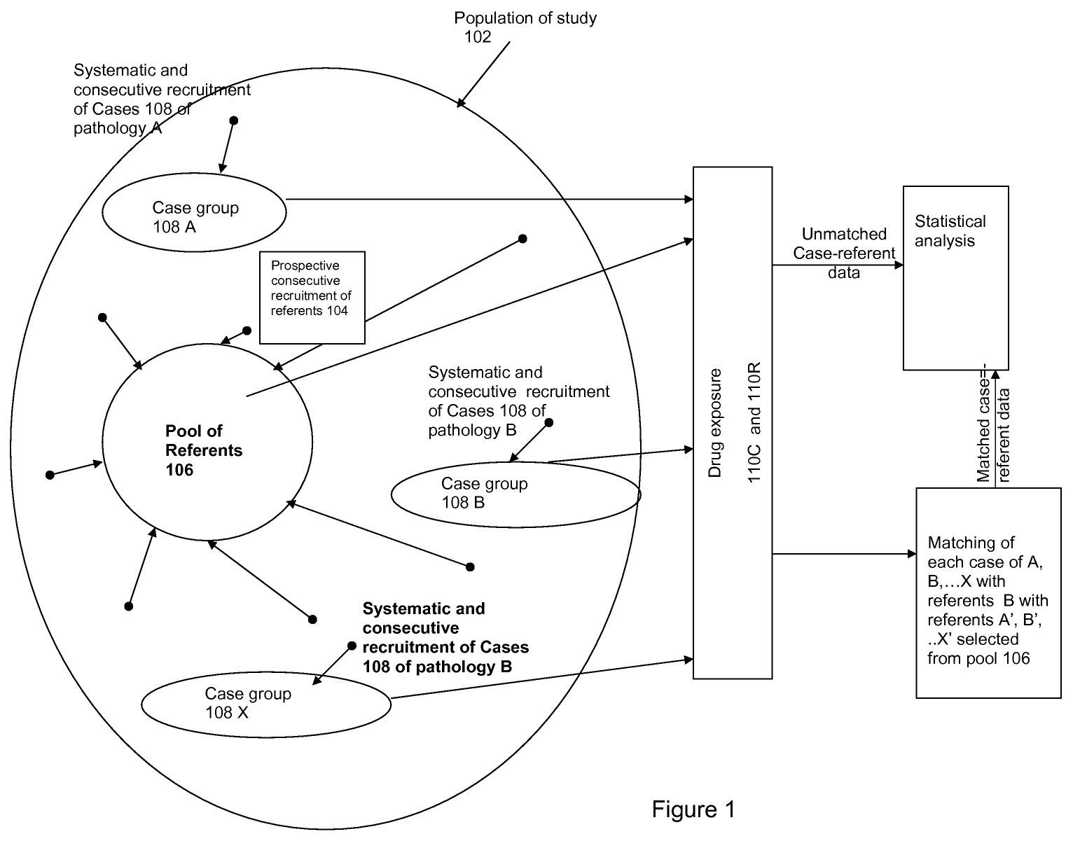

More precisely, as schematically presented in FIG. 1 for example, for pathologies of interest A, B, . . . X, a systematic consecutive recruitment of individuals exhibiting the respective pathologies, i.e. of indentified cases 108, is performed, in a given population of individuals 102. The cases 108 are also referred to as “adverse events”, as opposed to “adverse reactions”, since no hypothesis is made a priori on their causality. A case group 108A, 108B, . . . , 108X is thus formed for each pathology A, B, . . . X of interest respectively. For each recruited case, data are collected, including at least drug exposure data 110C.

Independently, a systematic consecutive recruitment of non-pathological cases 104 is performed to build a pool 106 of potential referents, also from the given population of individuals 102. For each recruited potential referent, data are collected, including drug exposure data 110R.

Systematic consecutive recruitment of both cases and potential referents, i.e. provision that they are recruited as they appear chronologically without selection, limit considerably selection biases that may occur in other methods.

Thus, a systematic case-referent database available for drug studies is generated, comprising, for a number of pathologies, cases grouped in cases groups, a pool of potential referents, and for each individual of the case groups and for each potential referent, drug exposure data 110C and 110R respectively.

Then, whenever needed, available individuals of a case group 108A, 108B, . . . , 108X with associated data 110C can be selected and matched with a subset A′, B′, . . . X′ of potential, thus becoming controls for the case A, B, . . . X, as defined hereinabove, each with associated data, sampled from the available pool 106 of potential referents 104, according to matching criteria predetermined in order to ensure representativity and comparability, as will be discussed hereinabelow.

Then, statistical analysis 112 is performed on the data of each individual of the case group 108A, 108B, . . . , 108X and of the respective control subset A′, B′, . . . X′, generally in accordance with pre-established needs of a given pharmaco-epidemiological study, as known in the art.

The given population 102 is generally formed of individuals characterized by at least one common factor. For example, such common factor may be the geographical location of residence, age (a population of young children under a given age or of elderly people over a given age for example), gender, or a combination thereof.

Both cases and referents are recruited regardless of their medical history, previous to their index date (for the cases), as will be discussed hereinbelow, or to their recruitment date (for the potential referents).

Since individuals in a given population may or may not have been exposed to a number of drugs, therapeutic products or classes that were present in specific geographical areas at specific calendar times, the exposure to a large number of drugs, or the prevalence of exposure, of each individual recruited as cases and as referents in a population is systematically documented. During the statistical analysis, the drug exposure of each cases can thus be compared to the drug exposure of the sampled referents that have been matched to the cases. This allows assessing long term or infrequent effects of drugs on the risk that an individual in a population exhibits a pathology.

Eligible potential referents include residents of the same geographical region in which the cases are recruited within given calendar periods.

The sampled subjects selected from the pool of potential referents, to be matched or compared as controls to cases of a specific pathology, may not have experienced the pathology or adverse event of interest at the time of their recruitment, and may have had some opportunity of exposure to one or more of the drugs of interest and meet the inclusion and exclusion criteria that would be used in a regular ad-hoc case-control study.

The recruitment of cases and the recruitment of potential referents are performed in parallel, essentially during a common given period of time.

As people in the art will appreciate, the systematic recruitment of potential referents to form a continuously augmented pool of potential referents ensures a rapid access to a large number of referents to be potentially sampled as controls for the needs of specific analyses with regard to a given pathology.

It is to be noted that an individual from the pool of potential referents may be selected as a control for different cases from different pathologies, which greatly increases the efficiency of the present method. For example, as shown in FIG. 1, each one of the recruited cases of several pathologies A, B . . . X 108, from the same population of interest 102, may be matched 110 to subsets of controls selected from the pool of potential referents 106 prior to statistical analyses 112. Obviously, the matching criteria may differ for each pathology.

Collection of drug exposure data of each recruited case of surveyed pathologies and each referent allows the constitution of a continuously updated information system on these pathologies and potential referents respectively.

As mentioned before, the systematic recruitment of cases and referents allows reducing a number of biases commonly found in standard case-control study designs.

As is standardly done in ad hoc methods, the present method allows the selection, matching, and comparisons of drug exposures between cases and controls based on specific criteria defined to verify some hypothesis or in response to an alert for example.

Moreover, pre-established protocols and standard operating procedures (SOP) may be used for the recruitment of both the cases and the potential referents, and for the collection of data regarding each of the background and/or medical-type characteristics of each recruited case and potential referent.

At least one structured database is used to compile and store the data of each recruited case and referent for later data extraction or retrieval. The at least one database may be computer-based and maintained, updated and used for data extraction on a routine basis.

The statistical analysis may be performed by computer means. If performed periodically on a routine basis, it may be used to conduct systematic surveillance or so called ‘data mining’.

In the following description, specific aspects and embodiments of the present invention are described in further details with regard to methodology and data ascertainment.

### Case Definition, Identification and Recruitment

Cases are recruited in a given population using a strict case definition, generally pre-established by experts in the field of each pathology of interest, which proceeds with inclusion and exclusion criteria based on detailed clinical signs and symptoms, and/or laboratory and/or imaging findings and other clinical features where appropriate (such as severity grading, clinical evolution, etc.).

The recruitment of the series of cases of the different pathologies is made on an on-going and systematic basis.

Case definitions usually adapt standard definitions provided in clinical guidelines or consensus reports to the specific situation of identification of risk factors. For example, the consensus reports usually define a case whenever all diagnostic criteria are met, which may take several months, even years for some diseases.

To overcome such delays, several levels of case definitions are allowed, considering for example definite, probable, and possible cases, thereby allowing for documentation of risk factors that may have occurred before the earlier symptoms and signs of the disease.

Non-limiting examples of general inclusion criteria comprise: age of patients, the fact that patients can be reached by telephone, the fact that patients can speak a given language, the place of residence of the patients in the geographical area of recruitment. Non-limiting examples of general exclusion criteria comprise: the fact that patients refuse to participate to a study.

In an embodiment of the present invention, only “incident cases” from eligible cases who satisfy the general inclusion and exclusion criteria are considered. “Incident cases” are defined as those who have been diagnosed as exhibiting the pathology of interest for the first time in their life or within a time period of interest. Such selection of incident cases allows avoiding a possible survival bias and other methodological difficulties related to the risk of recurrence of adverse events.

According to the present invention, for each recruited case, an index date is established, which corresponds to the date of the first occurrence of signs, symptoms or diagnosis, depending on the pathology, suggestive of the first manifestation of the pathology under consideration. Being able to document with precision the first manifestation of the disease and recruit the cases as close in time as possible to this first manifestation also allows avoiding biases associated with the wrong attribution of adverse events to drugs actually taken after their occurrence (such as in the so-called protopathic bias when a drug is actually taken to treat the first symptom of the adverse event).

For each pathology of interest, cases are identified and recruited by case-recruiting units. A specific procedure and network may be pre-established for the recruitment of cases, by identifying, for each pathology, a network of recruiters for recruitment of cases.

Using different levels of access to care (general practice, specialty units of public hospitals or private specialty clinics, etc.) allows pinpointing different manifestations (symptoms) of a pathology, maybe at different stages thereof for example. Indeed, primary care medical services are usually dispensed by physicians or other health professionals who have first contact with patients seeking medical treatment or care. These occur for example in physician offices, clinics, nursing homes, schools, home visits and other places close to patients. Secondary care medical services are generally provided by medical specialists in their offices or clinics or at local community hospitals for patients referred by a primary care provider who first diagnosed or treated the patients, for those patients who required the expertise or procedures performed by specialists. Secondary health care services include for example both ambulatory care and inpatient services, emergency rooms, intensive care medicine, surgery services, physical therapy, labor and delivery, endoscopy units, diagnostic laboratory and medical imaging services, hospice centers, etc. Lastly, tertiary care medical services are provided by specialist hospitals or regional centers equipped with diagnostic and treatment facilities not generally available at local hospitals. These include for example trauma centers, burn treatment centers, advanced neonatology unit services, organ transplants, high-risk pregnancy, radiation oncology, etc.

The different case-recruiting units together form a recruiting network that permits including patients of various modes of presentation (for example via primary, secondary or tertiary health care level and with various severity of signs and symptoms) in a given region. Such variety of modes of presentation allows limiting the selection bias.

However, in the case of specific pathologies, such as auto-immune thrombocytopenia for example, which require highly sophisticated diagnostic procedures requiring the patients to be systematically referred to specialized centres for example, recruiting cases in one type of health facility only may be representative of the pathologies.

The number of units enrolled in a case-recruiting network during a given period generally depends on the required size of the case groups needed in a given study.

Typically, the case-recruiting units for a given pathology are individually informed of a pre-established recruitment procedure.

According to an embodiment of the present invention, case-recruiting physicians may identify and propose participation, consecutively, to all eligible cases who are discharged alive, from a given health care recruiting unit. If they accept, these eligible cases are recruited. The recruitment time span generally varies according to the pathology at hand, and is adjusted in order to maximise the chances of fulfilling recruitment objectives, if any, while limiting the risks of selection biases.

In an embodiment of the present invention, for each recruited case, a recruiting physician may document clinical diagnosis, inclusion and exclusion criteria, as well as laboratory and imaging data specific to the case definition, under the form of a case report form, such as an electronic case report form for example, thereby forming a source of information for the characteristics of each individual case.

Alternatively, all or part of the recruitment of cases may be conducted by nurses or research assistants under the supervision of a physician.

Targeted cases may also be recruited if required by the nature of the adverse event of interest, such as, for example, paediatric patients, pregnant women, elders, patients with a certain body mass index, etc. . . .

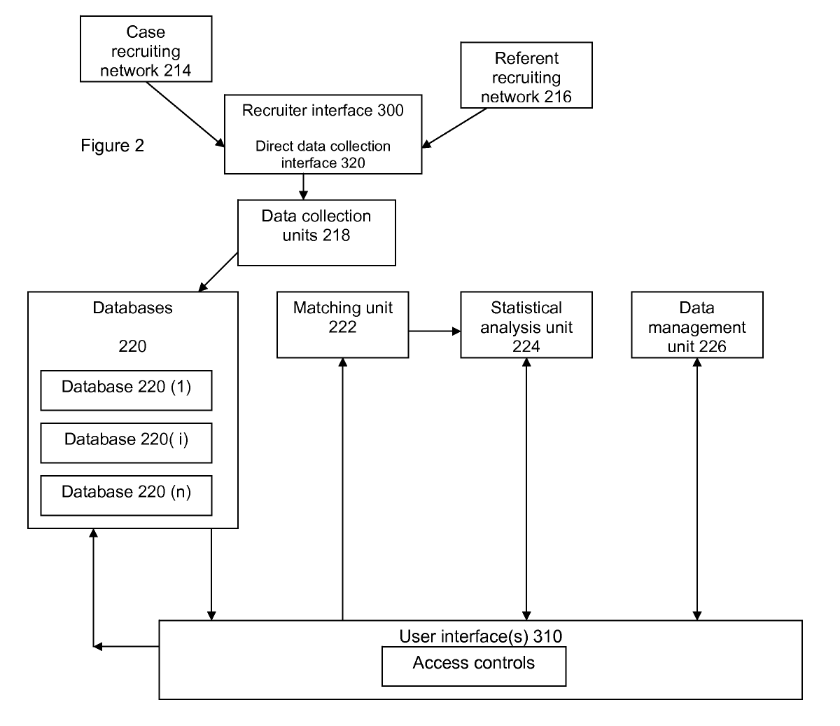

The recruited cases may be validated or reviewed by an expert panel 215 (see FIG. 2) that verifies the diagnostic criteria reported by the recruiting units, as listed on the case report form for example, according to validation procedures established for each pathology.

Some background characteristics of the selected cases, including socio-demographic characteristics for example, may be compared so as to evaluate the possible presence of a selection bias.

### Referent Identification and Recruitment

As described hereinbefore, potential referents are recruited on an ongoing basis from the pre-defined population of interest to form a pool of potential referents.

The recruitment of the pool of potential referents is made on an on-going and systematic basis.

In an embodiment of the present invention, the eligible referents may reside in the same geographical regions where cases are identified and be recruited within a similar time frame for example.

Eligible referents may have some opportunity of exposure to one or more drug of interest, for example when recruited by physicians in general practice or in other practice settings.

Recruitment of potential referents is made by physicians who are not usually involved in the recruitment of cases

In a particular embodiment of the present invention, recruitment of potential referents is made by physicians in general practice settings

In another particular embodiment of the present invention, recruitment of potential referents is made by physicians in out-patient clinics or emergency wards of hospitals

In another particular embodiment of the present invention, all or part of the recruitment of potential referents may be conducted by nurses or research assistants under the supervision of a physician without restriction as to the motive for consultation or health status, so as to avoid a selection bias. However, such data may be collected and stored for subsequent use for adjustment in the statistical analyses as needed. Otherwise, it is only at the matching stage that referents are selected from the pool of potential referents using criteria including a medical case definition.

The pool of potential referents may be recruited in a stratified sampling manner in order to facilitate further sampling of controls to cases within it. For instance, physicians may identify and propose participation to consecutive patients (i.e. as they present themselves, in each predetermined age and sex stratum) so as to recruit a total of 10 patients, namely 5 men and 5 women in each of the following age categories: 14-17, 18-34, 35-49, 50-64, 65-79. The number of patients to recruit per age-category may be increased, depending on the most needed age group regarding the surveyed pathologies. Thus the patients are asked consecutively, as they present to consultation, and if one of them refuses participation, the physician continues to propose participation to the next one in line, until 10 effective recruitments of potential referents are done. According to this example, a network of two hundred physicians enrolling ten patients over representative months in a given year may thus provide a pool of 2,000 referents per year. Moreover, spreading out recruitment evenly over the year insures adequate matching with occurrence of cases over a year.

The number of referents collected in a given stratum (age, gender or both) is adjustable as needed.

It is also possible to recruit referents with special inclusion criteria such as in the paediatric population for instance.

Physicians may be randomly selected from a general list of practicing physicians in a given region for example, and enrolled for the recruitment of potential referents in all regions where cases are recruited and in a sufficient number so to insure matching capacity (for example at least two potential referents per case on average). Within a given region, physicians may proceed to recruit patients as potential referents on a rotating basis so that recruitment is not interrupted in a given region over a given period of time.

The obtained pool of potential referents is closely monitored to insure representativity of the population of study. For example, the recruitment base of recruiting physicians in general practice on a given territory may be periodically reviewed to insure representativity of general practitioners on that territory, using national data on medical manpower. Moreover, a percentage of participating physicians may be periodically replaced.

Such recruitment of potential referents in a pre-specified time period by each physician allows minimising the risk of selecting potential referents based on their level of co-morbidity or frequency of visits, and thus to minimise a selection bias on the referents.

As described hereinabove in relation to the recruited cases, the drug exposure of each referent is documented. Physicians may provide the prescriptions of the two years prior to recruitment for each referent for example. Drug prescriptions are generally used as a secondary source of information in complement to the information obtained from the patient.

A direct data collection of other data, from voluntary recruited potential referents, may further be done to include for example occupation, lifestyle, type of medical insurance and quality of life. Indeed, a number of further data may be documented, if needed, such as medical and biological data, including medical history, under the form of a medical data form for each recruited potential referent, as a source of information for the characteristics of each referent.

### Drug Exposure Ascertainment

As mentioned above, drug exposure ascertainment is done using different sources including for example medical data provided by recruiters and direct data collection from cases and referents.

The documentation of drug use by all the cases and all the potential referents in the pool of potential referents is made on an on-going and systematic basis, whether they are used or not for a given study.

Since each recruited case and each recruited reference is characterised by its drug exposure, the present method allows assessing relative attributable risks, by comparing the risks of the cases with their exposure to the risks of the referents with their exposure.

In the systematic case-referent approach of the present invention, exposure to drugs is only pertinent for the period preceding the onset of the health event of interest. Therefore, all exposure to drugs in the patients' data collection and definition of exposure variables refers to the period preceding the index date, as defined for each recruited cases.

The direct data collection from both the cases and the referents may take the form of a structured interview.

For example all cases and potential referents may be submitted to a telephone-administered questionnaire by an operator, for example a trained interviewer, within a few days of their recruitment. In special circumstances where the patient is a minor or has communication or mental deficit (i.e. is recruited as a special case) for example, a proxy-responder may be interviewed instead, but this deviation to the standard interview procedure is then recorded to be taken into account in the analysis. The content of the interview and tools may be confidential.

In a specific type of interview and in order to stimulate the patients' memory of the drugs they have used, three approaches may be used in sequence: spontaneous recall, guided recall with a drug list, and guided recall with a detailed questionnaire.

A printed interview guide may be made available to all patients, and the patients be asked to look at the guide and check all health conditions and drugs from the lists provided, prior to the interview. At the beginning of the interview, the interviewer asks the patients to have the guide in front of them along with their copies of prescriptions and packages of their current medication. The use of such an interview guide is found to limit the recall or information bias by doing a systematic review of health problems and therapeutic classes of drugs, and to facilitate spontaneous recall, without a priori hypotheses.

Four time windows are used in sequence with patients for the memory recall of their use of medications, such as: one week, two months, one year and two years, previous to the index date. For the longer time windows (one and two years), the patients may be prompted, at the beginning of the interview, to identify life events that can mark the boundaries of each of those time windows. These life events do not have to be related to health and can be anything that helps the patients visualize the targeted period of time for memory recall.

The interview generally starts with a systematic review of a list of health problems. Health problems in the list are grouped under large classes that roughly correspond to systems, non limiting examples of which including cardiovascular and cerebro-vascular risk factors and pathologies, hypertension, respiratory and pulmonary problems, gastric problems, allergies, blood disorders. The interviewer may read the list so that no health problem is omitted in the memory recall of patients who are asked if they have taken any drug for any of the health problems on the list.

The interview guide may contain a drug list for each of the categories of health problems previously reviewed. The drug list generally contains a maximum of 20 drug names in each category of health problems, which are selected with priority criteria as follows for example:
new active principles that have been on the market for three years or less;
drugs targeted by risk management or surveillance plans;
drugs that have a potential for massive use in cases of an epidemic; and
finally, to complete each list to 20, drugs that have the highest sales and used by at least 0.5% of the population in one year.

The drug list presented to the patients in the interview guide may be revised periodically using the criteria mentioned above.

In a specific embodiment of the present invention, photographic visual displays of drug packages may be provided in the interview guide, when available, for some of the drugs among the 20 appearing in the list. The drug lists and drug visual displays provided are then systematically reviewed with the patients.

The interview guide may also contain a list of all vaccines available on the market, as well as questions for any type of drugs taken by the patients that are not on the drug list or are not recognized by the patients as belonging to any of the health problems reviewed.

Furthermore, patients may be invited to remember homeopathic, phytotherapeutic, traditional medicines, pharmacists' preparations and other types of medications that they may have been taking. In general, patients are instructed to report all drugs taken at least once in the two years previous to the index date, whether they were obtained by prescription, over-the-counter or from the family (friends) pharmacy. The interview further focuses on drugs taken on an ambulatory basis and also records medication obtained in a hospital if the patient can report them.

For each drug reported by the patients, a number of information is usually collected, including for example: the name of the drug, its dosage and form, the amount taken in 24 hours, the last time the drug was taken, the dates of first (in lifetime) and last takes, the mode of use (continuous, regular or sporadic), and substitutions with generic specialties of the same drug.

Such interview process is aimed at directly collecting general health information from the patients, either cases or referents.

### Data Collection on Co-Morbidities and Risk Factors

Characteristics associated with drug exposure and constituting risk factors for a given pathology are generally considered as potential confounders when assessing drugs. For example, co-morbidity, which generally designates the effect of all other diseases an individual patient might have other than the primary disease of interest, may constitute a confounder.

The documentation of behavioural risk factors and co-morbidities is made on an on-going and systematic basis for all cases and potential referents.

In a particular embodiment of the present invention, several types of information may be collected and used for controlling confounding, as well as performing interaction analyses.

For example, for each patient recruited, be it a case or a referent, participating physicians may provide a co-morbidity chart. In addition to co-morbidities, the physicians may also provide basic biologic data relevant to times preceding as close as possible the index date. The patients may also be asked directly, for example during the interview process, about their general risk factors and occupation. All these information may be collected on a routine basis.

The system allows for some other information to be additionally collected as needed for control of potential bias, depending on the type of pathology. In the case of pathologies such as multiple sclerosis for instance, a family history of the pathology may be added to the interview of the recruited patients.

### Statistical Analysis

The data collected on each recruited case and potential referent are compiled and stored in at least one database, from which they may later be extracted for specific needs of a given study. The analytic step of the method according to the present invention generally proceeds according to the case-control design, and different statistical approaches may also be used.

As illustrated in FIG. 1 described hereinabove, the analysis is sometimes done in absence of matching for pharmaco-vigilance type studies, for example, for comparing the frequency of drug use of cases with that of potential referents at large.

Most often, the analysis itself is preceded by the matching procedure whereby case-control sets are formed. Each case of a pathology is matched to a pre-determined number of controls according to a number of predetermined criteria, selected from the pool of potential referents in the database, as described hereinabove.

Non-limiting examples of such matching criteria include for example: sex, age (for example within a 5-year window, but it depends on the pathology of interest), time of recruitment (as close as possible to the date of recruitment of the case, for example not exceeding 3 months), place of residence (same recruitment region), Such exemplary criteria are selected to balance the distribution of confounders between cases and referents.

A type of statistical analysis that may be performed in a method according to the present invention is called crude analysis, for a general surveillance of adverse events and exposure to drugs or therapeutic classes without a priori hypothesis for instance. This is a case when the statistical analysis is performed without matching the cases with referents, as mentioned in relation to FIG. 1. Such analysis may be performed periodically on a routine basis as a crude comparison between sets of cases and sets of controls for their exposure to therapeutic products.

Thus, in an embodiment of the present invention, both cases and referents may be routinely recruited, on an ongoing fashion, to allow, for example, a general surveillance of several drugs, by recruiting and interviewing patients without a priori hypotheses about exposure, which is not the case in conventional case-control studies usually performed in an ad hoc fashion to answer a specific question about a specific exposure.

Interestingly, the method of the present invention thus, beside exploring several possible drug exposures, also allows collecting patient data without bias regarding a specific exposure, which, as people in the art will appreciate, is one problem of ad hoc case-control studies.

Since all cases and referents are dated (by the index date and date of recruitment, respectively) and the recruitment of both is prospective, the present invention further allows performing retroactive statistical analyses on a population of previously recruited cases and a corresponding subset of the pool of referents with regard to a geographical and time sampling frame. The present invention thus allows constitution of reality-based databases, ready-to use for future studies for a large number of pathologies, which stand available in case of an alert for example, which ad hoc case-control studies do not usually allow.

Another type of statistical analysis that may be performed in a method according to the present invention is called in-depth analysis, generally conducted on demand or after an alert. In such analysis, a specific hypothesis is specified and is tested regarding an adverse event and exposure to a specific drug or therapeutic class.

As known in the art, the in-depth analysis is generally performed using multivariate techniques considering all risk factors for a specific pathology (potential confounding variables) as well as co-medications. The association between a drug and the occurrence of an adverse event is quantified through adjusted odds ratios and their 95% confidence interval.

Special analyses may be also performed depending on the problem at hand. For example, propensity score analyses may be indicated where cases and referents are suspected to have different probabilities of exposure to a given drug or class of drug. In a specific embodiment of the present invention, the use of the propensity score is adapted either in the matching procedure or in the analysis for control of potential confounding, for example.

Interaction analyses may also be performed to test the effect of age, sex, time of year, past medical history, past drug use, etc.

Sensitivity analyses may be performed to assess the robustness of results to changes in a number of parameters.

For example, for a given pathology, a different set of referents may be randomly selected and all the analyses repeated. Results are compared to those obtained with the original set of selected referents.

Moreover, when a case is coded as certain, probable or uncertain, according to the case definition described hereinabove, the analysis may retain only the “certain” category first and then proceed with including the other categories in descending order of certainty.

Interestingly, due to the systematic prospective recruitment, the present invention further permits, when a pathology is associated with a fatality rate, to recruit cases of “near deaths” and use them to compare the risk with other cases and thereby document a potential “survival bias” with regard to the exposure.

As other methods and systems, the present invention also allows case cross-over analysis by using a case as its own control for a different passed time-window. Other effects can be used in sensitivity analyses depending on the problem at hand, such as accounting for the recruiting region or units.

### Information System and Databases

The present invention further provides a case-referent system for supporting, controlling and administering the implementation of a method as previously defined, for example on a large scale basis, such as that of a country or state.

As illustrated for example in FIG. 2, the system comprises a network 214 for recruiting cases according to inclusion/exclusion criteria, a network for recruiting referents within the population of study defined for the cases, and data collection units 218 for documenting drug exposure of each recruited case and each recruited referent. Databases 220 allow storing recruited cases and referents and at least their drug exposure. A matching unit 222 is used to match each case of a given pathology with a subset of referents from the pool of referents according to predetermined matching criteria, and a statistical analyses unit 224 uses these matched data in studies of the given pathology. The statistical analyses unit 224 may also use data extracted from the databases 220 directly, as mentioned hereinabove.

A system as described hereinabove, once installed and operational, may allow subscribers such as companies or governments to order specific studies and have some access, potentially proprietary, to all or part of the data, results and reports, including for example the interview questionnaires or crude analysis report.

Indeed, the present invention provides at least one structured database for receiving, organising, storing and later extracting data regarding the cases and the referents, and possibly also the case-recruiting units and general practitioners.

For example, a first database 220a may contain the identity of participating physicians and their patients while a second database 220b may contain data corresponding to the patients, used for statistical analyses, the two databases being segregated on a space with strict limited access control for traceability purposes only after all information is obtained on a patient. The user interface 310 give access to each database, for data management by unit 226 and/or analysis by unit 224 for example, according to this strict limited access control so as to ensure the confidentiality of the data.

The present invention thus provides a data processing system to enter, store and retrieve data, typically comprising at least one recruiter interface 300 to allow medical data entry on cases and/or referents and at least one user interface 310 to allow data retrieval, processing and analyses. The data processing system may further include a direct data collection interface 320 for entry of patient medical data following direct data collection of information from the patients. Such a data processing system may be web-based, with a secure Internet data entry and transmission protocol for entry of any confidential data such as background or medical-type information on cases or referents, as well as a protocol for allowing limited and secured access to authorized members only. A specific website may be provided for accessing the at least one web interface for recruiters, users, viewers or subscribers for example.

The system may further comprise an expert panel 215 validating diagnostic criteria reported by the recruiting units according to validation procedures established for each adverse event for example.

Thus, data may be routinely collected and securely entered into the system via the databases, following routine and ongoing recruitment of referents, and possibly also routine recruitment of cases.

The present invention further relates to a program such as a service-providing program for conceiving and maintaining an information system and supporting infrastructure such as databases that allow implementing a method according to the present invention.

For example, such a program may define specific requirements for case and referent recruitment in general, and for recruitment of the recruiting networks on both the cases' and referents' sides, as well as coordinate the creation of the networks and appropriate information distribution to each acting member of the information system.

Such a program may for example provide training on the data entry system to the case recruiters, for example via Internet, and provide all other tools for recruitment (information to patients, consent forms, drug list and drug display for patients), which are for example paper tools.

Such a program may also, in the specific context of a web-based information system for example, enrol general practitioners who have access to Internet and use an electronic patients' record system such as computerized prescriptions, provide the volunteers with a secured access to the information system on Internet, and instruct them on on-line filling of the medical data form and the electronic transfer of their computerized drug prescriptions over the previous two years along with an anonymous extract of the electronic patients' record.

According to an embodiment of the present invention, a specialized call centre may be created, for recruiting and training its own interviewers to proceed with the direct data collection from the patients, and more specifically with the patients' structured interviews as described hereinabove. Each interviewer recruited may for example receive a basic training on how to approach a patient on the telephone, on the patient interview with special emphasis on drug exposure ascertainment, and on data security. An instructors' manual may also be developed to that effect. Trained interviewers may participate in the training of newcomers in order to insure homogeneity of method across all interviews. Interviewers may be required to sign a confidentiality agreement before they start doing interviews.

Such a call centre may be equipped with an automated call monitoring system that coordinates the contacts with physicians and patients in specific delays such as those prescribed in the procedures.

Quality control procedures may also be implemented in a system according to the present invention. Such quality control may include the monitoring of interviews as follows. All interviews may be taped and stored in a secured database. Each interview may be monitored for its duration and given a “difficulty score” by the interviewer according to the difficulty to obtain information from a patient. Statistics on duration and difficulty by interviewer and day and time of interview may then be reviewed on a weekly basis.

The operations of a system according to the present invention for data collection, utilisation, transfer and storage, may be coded in a Standard Operating Procedures (SOPs) manual. Each procedure may thus be controlled by a specific monitoring system and subjected to regular internal audit. An audit trail may be maintained through all SOPs in the information system and internal audit may be performed on a routine basis.

As another quality control measure, the present system may include a regular contact between administrators of the system and the physicians recruiting cases and/or referents about their recruitment progress and queries on their recruited patients.

A toll-free number may advantageously be made available to case-recruiting units or physicians who need to inquire about specific cases or diagnostic criteria, as well as to the study subjects (cases or referents).

Data security may be embedded in all SOPs where pertinent on confidentiality, integrity and accessibility issues. Confidentiality is partly insured by the physical separation of databases containing the identity of participating physicians and their patients, and the health information used for statistical analyses for example. The identity of participants is used for scheduling interviews, sending reminders and an information bulletin. The link between the medical database and the identity of patients may be kept in a space with strictly restricted access for traceability purposes during audits if required, and the written consent of patients is required. Integrity is partly checked by computerized routines that are programmed to detect errors and inconsistencies in the database. For example, all personnel working with the information system may be specially trained on data security and have a pre-determined access to the information. A strict code of conduct may be advantageously maintained in all operations.

With regard to ethical considerations, participation of cases and referents is sought through informed consent form. The form and a summary of the system are provided to the patient by their physicians upon proposition to participate in a study. Thus, the system may be made to comply with regulatory requests regarding patient privacy protection and ethical requirements in each country of interest.

From the foregoing, it should now be apparent to people in the art that the present invention, by constituting cases groups and a large pool of referents via a systematic and consecutive recruitment of individuals, without any restriction with regard to their health history, and collection of data on their possible pathologies and drug prescriptions within a given time-period preceding their recruitment, allows a rapid availability of a large number of referents for the needs of a specific study, such as a study required following a pharmaco-vigilance alert. In contrast, in conventional case-referent studies, the definition and finding of an adequate referent for each recruited case remains a time-consuming challenge.

Moreover, by systematically recruiting a minimal number of cases of pathologies, according to precise and well-defined case definitions, in a given time period, the present invention allows continuously obtaining and compiling information on the studied pathologies and constituting a database of cases for such pathologies with or without any considerations regarding possible pharmaco-vigilance risk signals or alerts, literature or crisis period of a particular drug or therapeutic class. This also allows, for example, establishing a base network of case-recruiting units to be rapidly mobilised whenever a more important sample of cases may be needed for a given pathology. Adverse events that are so routinely recruited may correspond to pathologies continuously studied in the information system according to the present invention, and may be qualified as standard cases.

Any pathology may be studied in an information system according to the present invention. Generally, pathologies to be routinely studied are selected according to criteria including: (1) they are serious or can potentially evolve into serious conditions; (2) they correspond to some adverse events that led to the market withdrawal of products over the past 40 years (a list that is updated overtime); and/or (3) they are suggested by regulatory authorities as significant issues.

For very rare diseases, increasing the number of cases may require the participation of additional case-recruiting units. In some instances, the number of cases in the system may be limited by the number of existing cases.

On demand, the present invention may advantageously enable the addition of cases of pathologies that are not routinely collected. This task is rendered much simpler than setting up a de novo study since it taps on the entire infrastructure edified for the collection and interview of routine cases on the one hand, and uses the routine pool of referents on the other hand. In a specific embodiment, the system is continuously calibrated to recruit on demand extra referents to fill the need of matching to cases (special or standard). In many instances, targeted cases may be recruited in case-recruiting units that already contribute to the collection of routine cases since a large set of medical specialties are represented in the routine set up.

The study of risks in certain situations may also require the building of a new case and referent collection module. This may be the case for instance of paediatric cases or those with mental deficits. Specialized recruitment modules may thus be created with the appropriate tools and appropriate referents must be defined and recruited. The treatment of the information would then be similar to the other types of cases in the present system.

The present system may be designated as a PGRx™ information system, which follows the guidelines for Good Pharmaco-epidemiology Practice (GPP), as given on the website of the International Society for Pharmaco-epidemiology (ISPE).

Examples of a pathologies routinely studied in the PGRx™ system and the study currently being implemented are myocardial infarction and acute coronary syndromes, central demyelination and multiple sclerosis, Guillain-Barré syndrome, systemic and cutaneous lupus, polyarthritis, myositis and dermatomyositis, type 1 diabetes mellitus, autoimmune thyroiditis and Grave-Basedow disease, thrombocytopenia, suicidal attempts and depression.

For myocardial infarction (MI), for instance, the case definition is based on clinical guidelines that are contemporary to the recruitment and include two out of three symptomatic, enzymatic and electrical (electro-cardiogram) diagnostic criteria. Only first lifetime occurrences of Ml are included as cases and patients with previous cardiac surgery or catheterization are excluded. The index date is defined as the date of the Ml. A list of cardiologists was used to randomly select and recruit a network of 50 cardiologists over a period of three months who recruited each between 1 and 25 cases for a goal of 500 cases over one year. Each enrolled cardiologist is registered to the system with the assistance of a specially trained PGRx™ agent, by telephone or on site, using a registration package which includes a presentation of the system, information for logging in the secured PGRx™ Web site, information on maintenance of a case registry and recruitment log, interview guides and information for the patients and consent forms.

Cases are recruited consecutively in time and interviewed within one month of their MI. Cardiologists record the medical information via their secured Web site access and interviews are entered directly in the database. Up to 10% of recruiting cardiologists are audited for conformity of the medical information with the medical chart and completeness of the recruitment log and eligible case registry.

While case recruitment proceeds, referent recruitment occurs independently with a network of 200 physicians in general practice using a similar strategy as for the cardiologists. The goal of recruiting 2000 subjects per year is easily achieved and the intensity of recruitment is adapted (accelerated or slowed down) according to the monthly recruitment objective. Referents are interviewed within one month of their recruitment. Overall, the average number of drugs taken at least once in the two years preceding the index date and documented per subject is ten.

Once all information has been gathered on cases and referents, identifiers such as background information are removed from the analytical database. The analysis accounts for potential confounders and interaction effects such as cardio-vascular co-morbidities and co-medication, hypercholesterolemia and smoking.

The present system, method and database allow performing post-marketing surveillance and evaluation of drugs while controlling a number of biases, which are known to decrease the quality of standard case-control studies. As a result, they provide a quality of data and statistical strength superior to current automated pharmaco-epidemiological systems, methods and databases.

Although the present invention has been described hereinabove by way of specific embodiments thereof, it can be modified, without departing from the nature and teachings of the subject invention.

1. A method for surveying and assessing the contribution of drugs risks of adverse events, comprising:
a) identification and studying:
i) a plurality of case-groups of different categories of adverse events, each case of a given case-group being faced with a given adverse event;
ii) a pool of potential referents identified regardless of a previous medical history thereof; and
iii) a large number of drugs and vaccines used by the cases and the potential referents;
b) selecting controls sampled from the pool of potential referents according to predetermined criteria;
c) matching the controls to specific cases of the case-groups; and
d) conducting statistical analyses by comparing cases and controls to identify drugs that are susceptible to be associated with a modified risk of at least one of the adverse events and factors associated with this risk;
wherein said steps a) to d) are performed on a systematic prospective on-going plan.

2. The method of claim 1, wherein said steps a) and said step b) are performed in parallel during a common period of time.

3. The method of claim 1, wherein said step identifying the referents for the pool of referents is performed independently of the adverse events and in absence of a priori reference to the adverse events.

4. The method of claim 1, wherein said steps a), b), c) and d) are performed simultaneously for a number of different adverse events.

5. The method of claim 1, wherein said step a) comprises an ongoing systematic recruitment and documentation of individuals facing the adverse events as cases.

6. The method of claim 1, wherein said step a) comprises an ongoing systematic recruitment and documentation of individuals facing or not facing the adverse events as potential referents.

7. The method of claim 1, comprising defining a pre-defined population for step a) according to geographical and time sampling frames.

8. The method of claim 1, comprising defining a pre-defined population for step a) formed of individuals characterized by at least one common factor.

9. The method of claim 1, wherein step a) is performed in a same region and within a same calendar period for the cases and the potential referents.

10. The method of claim 1, wherein said step b) comprises forming a subset of referents to be matched as controls to the cases in step c).

11. The method of claim 1, wherein said step d) is performed periodically on a routine base.

12. The method of claim 1, wherein said step d) is performed based on criteria defined in response to one of: i) an hypothesis and ii) an alert.

13. The method of claim 1, further comprising the step of compiling and storing characteristics of each case and each potential referent in at least one database.

14. The method of claim 1, wherein said step a) is performed using inclusion and exclusion criteria.

15. The method of claim 1, wherein said step a) is performed by at least one recruiting network.

16. The method of claim 17, wherein the at least one recruiting network comprises a case-recruiting network.

17. The method of claim 16, wherein the case-recruiting network includes a range of sources.

18. The method of claim 1, wherein said step a) further comprises reviewing and validating the cases by an authorised panel.

19. The method of claim 1, wherein said step a) comprises recruiting potential referents susceptible of exposure to one of the drugs.

20. The method of claim 1, wherein said step a) comprises recruiting potential referents independently of a health status thereof.

21. The method of claim 1, wherein said step b) comprises selecting controls sampled from the pool of potential referents according to predetermined criteria including health status.

22. The method of claim 1, wherein said step a) comprises recruiting potential referents by a referent-recruiting network.

23. The method of claim 22, wherein said recruiting is performed in a stratified-sampling manner.

24. The method of claim 1, wherein said step a) comprises obtaining drug exposure ascertainment, for each case and each potential referent.

25. The method of claim 24, wherein said obtaining drug exposure ascertainment is performed from medical data provided by at least one of: i) recruiters, ii) insurance providers, and iii) direct data collection from cases and potential referents.

26. The method of claim 1, further comprising systematically assessing and comparing exposure to drugs of the cases and of the controls.

27. The method of claim 1, wherein said step d) is one of: i) a crude analysis and ii) in depth-analysis.

28. The method of claim 1, wherein said step a) comprises documenting a date of first manifestation of the adverse events for each case.

29. The method of claim 1, wherein said step a) comprises documenting a date of recruitment for each potential referent.

30. The method of claim 24, wherein said direct data collection comprises providing each potential referent and each case with a list of drugs and stimulating each potential referent's and each case's memory in relation to prior drug use.

31. The method of claim 30, comprising a systematic review of a list of health problems with each case and each potential referent.

32. The method of claim 30, where said memory stimulating is done through time windows.

33. The method of claim 1, further comprising selecting a random subset of potential referents, repeating step d) with the random subset and comparing results of analysis with the controls and with the random subset.

34. The method of claim 1, wherein said step d) comprises assessing relative attributable risks.

35. A system for surveying and assessing the contribution of drugs to the risk of adverse events in a pre-defined population, comprising:
at least one referent recruiting unit, said at least one referent recruiting unit forming, from the pre-defined population, a pool of potential referents regardless of their medical history;
at least one data collection unit, said data collection unit collecting at least drug exposure data of each recruited case and each recruited potential referent;
at least one case-recruiting unit for each adverse event, said at least one case-recruiting unit forming a case group for the adverse event from the pre-defined population, each case of the case group being faced with the adverse event;
at least one data collection unit, said data collection unit collecting at least drug exposure data of each recruited case and each recruited potential referent; and
at least one database, said at least one database comprising the identifiers of the recruited cases, the recruited potential referents and associated collected data;
wherein said recruiting units and at least one data collection unit are adapted to operate on a systematic prospective on-going plan.

36. The system of claim 35, further comprising a processing unit adapted, for each case group, to select controls sampled from the pool of potential referents and match the cases of the case group and the controls according to predetermined matching criteria; and to perform a statistical analysis on data of each case and each control.

37. The system of claim 35, further comprising an expert panel, said expert panel validating diagnostic criteria reported by the recruiting units according to validation procedures established for each adverse event.

38. The system of claim 35, further comprising at least one recruiter interface to allow data entry on at least ones of: i) the cases and ii) the potential referents, and at least one user interface to allow data retrieval, processing and analyses.

39. The system of claim 35, further comprising at least one interface for entry of data following direct data collection of information from the at least ones of: i) the cases and ii) the potential referents.

40. A ready-to-use case-referent database set, comprising:
a number of case groups, each case group comprising cases of a given pathology with identifiers of cases, recruited from a pre-determined population in a systematic consecutive way, each case being assigned an index date;
a number of data corresponding to each case of each case group;
a pool of potential referents comprising potential referents recruited from the pre-determined population in a systematic consecutive way, each potential referent having an identifier and being assigned a recruitment date; and
a number of data corresponding to each recruited potential referent.

41. The set of claim 40, further comprising, for each case group, a number of case-control pairs, wherein the pairs are formed by selecting controls from the potential referents and matching the cases of the case group with the controls according to predetermined matching criteria.

42. The set of claim 40, wherein the identifiers of the cases are separated from the data corresponding thereto.

43. The set of claim 40, wherein the identifiers of the referents are separated from the data corresponding thereto.

44. A method for collecting drug exposure data from patients, comprising at least one of:
a) submitting a list of drugs to the patients; and stimulating the patients' memory of drug use using time windows; and
b) submitting a list of health problems to the patients.
